(19) United States
(12) Patent Application Publication
(10) Pub. No.: US 2011/0290845 A1
(43) Pub. Date: Dec. 1, 2011

(54) FISHING POLE SUPPORT SYSTEM

(76) Inventor: WILLIE JACKSON, Climax, GA (US)

(21) Appl. No.: 12/789,134

(22) Filed: May 27, 2010

(51) Int. Cl. A45F 5/00; A01K 97/10

(52) U.S. Cl. 224/661; 43/21.2

(57) ABSTRACT

A fishing pole support system for mounting and supporting a fishing pole comprising: a waist belt, where said waist belt is capable being is strapped around a user's waist; a Velcro strap, where said Velcro strap extends around the outer portion of the belt; a rod holder provided on one side of the belt; a leg strap, where said strap that extends vertically downward from the belt; and a means to secure the leg strap to the leg of the user. The belt may be adjusted and secured through the use of the Velcro strap. The rod holder may be a loop type of holder that provides a mechanism to insert a fishing rod there through. In one particular embodiment, adjustment buckles are provided along the length of the leg strap and provide a mechanism to vertically adjust the leg strap to suit the user.

### BACKGROUND OF THE INVENTION

1. Field of Invention

The present invention relates to a waist belt/leg harness to support a fishing pole.

2. Description of Related Art

Fishing rod holders are used by fisherman to brace and support a fishing rod in various positions while fishing. Many fishing rod holders are driven into the ground and provide a means to prop and hold a fishing rod after the fishing line has been cast into the water. The fishing rod holder is convenient and allows the fisherman to rest the rod in the holder until a fish is caught on the hook. Similar holders hold fishing rods mounted on boat and again provide a means to support the fishing rod while waiting for a fish to bite on the fishing hook. Once the fish has been hooked, it is therefore the task of the fisherman to reel the fish in. On some occasions, a body harness or support may be necessary to hold the fishing rod while the fisherman reels the fish in. Depending on the size of the fish, this could be a time consuming process and it is necessary to maintain leverage on the fishing pole as the fish is reeled in.

Some examples of braces and supports that allow for the bracing of a fishing rod while the support is attached to the person's body include U.S. Pat. No. 6,269,990 that discloses apparatus for holding an elongated device such as a fishing rod and includes a tube for receiving an end of the fishing road to a depth effective to retain the fishing rod and includes a leg brace for attachment to the user's leg. Another example of a fishing rod brace is disclosed in U.S. Pat. No. 6,357,639 that discloses a holster that includes durable waterproof synthetic woven fabric where the holster is attached to the outer side of the fisherman's lower leg and therefore provides a means for mounting a fishing pole with the lower leg of the fisherman. Yet another example of a body support harness for a fishing pole is disclosed in U.S. Pat. No. 6,591,542 that discloses a body support harness that supports the end tip of a fishing rod on the thigh of a user. The body support harness includes a base member for positioning adjacent to the thigh of the user, a first mounting strap for mounting the base member to the thigh of the user and a rod holder for receiving the end of a fishing rod.

It is noted that many of the support harnesses of the prior art are attached to the leg or thigh of the user, however the support appears to be limited to and provided by one limb of the user. It would be advantageous to have a support harness that attached closer to the torso and may use the leg as a supplemental support for the fishing pole.

### SUMMARY OF THE INVENTION

The present invention relates to a fishing pole support system for mounting and supporting a fishing pole comprising: a waist belt, where said waist belt is capable being is strapped around a user's waist; a Velcro strap, where said Velcro strap extends around the outer portion of the belt; a rod holder provided on one side of the belt; a leg strap, where said strap that extends vertically downward from the belt; and a means to secure the leg strap to the leg of the user. The belt may be adjusted and secured through the use of the Velcro strap. The rod holder may be a loop type of holder that provides a means to insert a fishing rod there through. In one particular embodiment, adjustment buckles are provided along the length of the leg strap and provide a means to vertically adjust the leg strap to suit the user. The leg strap may be anchored to the user's leg through the use of a pair of horizontal leg straps, where the horizontal leg straps include Velcro as a means to anchor and support the leg straps around the user's legs.

### BRIEF DESCRIPTION OF DRAWINGS

FIG. 1 depicts a fishing pole support system and harness according to the present invention.

### DETAILED DESCRIPTION

The present invention relates to a fishing pole support system that is strapped around the waist of the user to provide a harness support for a fishing pole. The support system according to the present invention extends down the user's leg so that support for the fishing pole is provided by the user's torso and one leg to brace while maneuvering a fishing pole that is inserted into a holder. The holder and harness according to the present invention are conveniently strapped around the user's waist with the use of a brace belt and Velcro straps for adjustment thereof. A leg strap extends vertically down the user's leg, is adjustable and straps around the user's leg as a vertical support system for the harness.

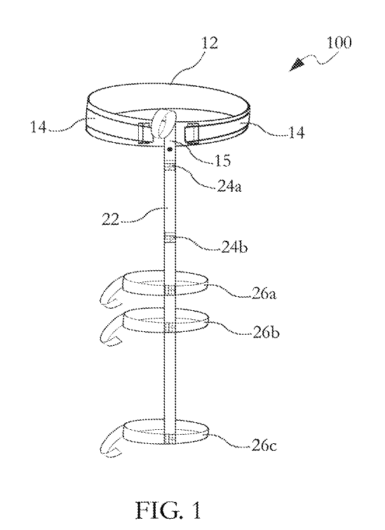

In reference to FIG. 1, a Fishing Pole Support System 100 according to the present invention is depicted. The Fishing Pole Support System 100 includes a Waist Belt 12 that is strapped around a user's waist as a permissible means of support of the Support System 100. The belt is adjusted and secured through the use of Velcro Strap 14 that extends around the outer portion of the Belt 12. A Rod Holder 14 is provided on one side of the belt. The Rod Holder 14 is a loop type of holder that provides a means to insert a fishing rod there through.

In addition to the Waist Belt 12, a Leg Strap 22 that extends vertically downward from the Waist Belt 12 provides further support for the System 100. Adjustment Buckles 24a, 24b are provided along the length of the Leg Strap 22 and therefore provide a means to vertically adjust the Leg Strap 22 to suit the user. The Leg Strap 22 is anchored to the user's leg through the use of Leg Straps 26a, 26b, 26c. The Leg Straps 26a, 26b, 26c also include Velcro as a means to anchor and support the leg straps around the user's legs.

The Fishing Pole Support System 100 provides an effective means to support a fishing pole and to assist the user in reeling in fish that are captured upon the hook of the fishing pole. The Pole Support System 100 according to the present invention is anchored about the user's waist and therefore is a stable and strongly supportive means to support the fishing pole and to control the retrieval of the fish on the hook. The support system is adjustable due to the waist belt and adjustment features provided along the Leg Strap 22. Once firmly strapped into place, the support system helps to reduce energy that's required to control the fishing pole and fish and provides a firm means for leveraging the fishing pole through the Holder 15. The post support system according to the present invention is readily adjustable and provides a unique means to support a fishing pole while fishing. The instant invention has been shown and described in what it considers to be the most practical and preferred embodiments. It is recognized, however, that departures may be made there from within the scope of the invention and that obvious modifications will occur to a person skilled in the art.

What is claimed is:

1. A fishing pole support system for mounting and supporting a fishing pole comprising:
a. a waist belt, where said waist belt is capable being is strapped around a user's waist;
b. a Velcro strap, where said Velcro strap extends around the outer portion of the belt;
c. a rod holder provided on one side of the belt;
d. a leg strap, where said strap that extends vertically downward from the belt; and
e. a means to secure the leg strap to the leg of the user.

2. The fishing pole support system according to claim 1, where the belt is adjusted and secured through the use of the Velcro strap.

3. The fishing pole support system according to claim 1, where the rod holder is a loop type of holder that provides a means to insert a fishing rod there through.

4. The fishing pole support system according to claim 1, where adjustment buckles are provided along the length of the leg strap and provide a means to vertically adjust the leg strap to suit the user.

5. The fishing pole support system according to claim 1, where the leg strap is anchored to the user's leg through the use of a pair of horizontal leg straps, said horizontal leg straps provide the means to secure the leg strap to the leg of the user.

6. The fishing pole support system according to claim 5, where the horizontal leg straps include Velcro as a means to anchor and support the leg straps around the user's leg.
